(19) United States
(12) Patent Application Publication
(10) Pub. No.: US 2026/0217937 A1
(43) Pub. Date: Jul. 30, 2026

(54) POLYAMIDE RECOVERY METHOD AND POLYAMIDE RECOVERY SYSTEM

(71) Applicant: HONDA MOTOR CO., LTD., Tokyo (JP)

(72) Inventors: Haruki CHIBA, Saitama (JP); Yasushi TERASAKA, Saitama (JP)

(21) Appl. No.: 19/460,319

(22) Filed: Jan. 27, 2026

(30) Foreign Application Priority Data
Jan. 29, 2025 (JP) 2025-012974

(51) Int. Cl. C08J 11/08; C08J 11/02

(52) U.S. Cl. CPC C08J 11/08; C08J 11/02; C08J 2377/00

(57) ABSTRACT

A polyamide recovery method recovers polyamide using a solvent from polyamide mixed with fibers as a product containing fiber and polyamide. The polyamide recovery method includes the following steps. In the dissolution step, the polyamide mixed with fiber is immersed in a solvent to dissolve the polyamide in the solvent. In the first separation step, a polyamide solution as a solvent in which the polyamide is dissolved, and a cake containing fibers are separated from each other. In the solution recovery step, the polyamide solution is recovered. In the washing step, the cake is washed with a solvent in a pressurized washing vessel. In the second separation step, a post-wash solvent as the solvent after washing the cake, and the cake after washing are separated from each other. In the solvent recovery step, the post-wash solvent is recovered.

This application is based on and claims the benefit of priority from Japanese Patent Application No. 2025-012974, filed on 29 January 2025, the content of which is incorporated herein by reference.

### BACKGROUND OF THE INVENTION

### Field of the Invention

The present invention relates to technology for recovering polyamides using a solvent, from polyamide mixed with fibers as a product including fibers and polyamide.

### Related Art

In recent years, efforts directed at a significant reduction in the generation of waste materials are becoming more active, by the prevention or reduction of waste generation, recycling and reuse. Towards this realization, research and development is being carried out into technology for the recovery of various waste materials. Among these technologies, there is technology for separating and recovering polyamides from polyamide mixed with fibers as products including fibers and polyamide.

Patent Document 1: Japanese Unexamined Patent Application, Publication No. 2024-125271

### SUMMARY OF THE INVENTION

With such technology, normally the polyamide mixed with fibers are first immersed in solvent to dissolve the polyamide in the solvent. Next, the polyamide solution of the solvent in which this polyamide dissolved, and a cake containing fibers are separated from each other by centrifugation or the like. By recovering this separated polyamide solution, the polyamides are recovered.

However, in this case, upon separating the polyamide solution and cake from each other, a certain amount of polyamide is blended into the cake side. Due to this, a polyamide recovery loss occurs.

The present invention has been made in view of the above situation, and has an object of reducing the polyamide recovery loss.

The present inventors have found that the above-mentioned object can be achieved if separating a polyamide solution and cake from each other, followed by washing this cake with solvent. The present invention is the following polyamide recovery methods of (1) to (9) and polyamide recovery system of (10).

(1) In a polyamide recovery method for recovering polyamide using a solvent from a polyamide mixed with fiber as a product containing fiber and polyamide, the method includes: a dissolution step of immersing the polyamide mixed with fiber in a solvent to dissolve the polyamide in the solvent;

a first separation step of separating a polyamide solution as the solvent in which the polyamide is dissolved, and a cake including the fiber from each other;

a solution recovery step of recovering the polyamide solution;

a washing step of washing the cake with a solvent inside a washing vessel that is pressurized therein;

a second separation step of separating a post-wash solvent as the solvent after washing the cake, and the cake after washing from each other; and

a solvent recovery step of recovering the post-wash solvent.

According to the present configuration by separating the polyamide solution and the cake from each other, and then washing this cake with solvent, it is possible to dissolve the polyamide remaining in the cake into the solvent. The amount of polyamide remaining in the cake is thereby reduced, and thus the polyamide recovery loss can be reduced.

Moreover, by pressurizing inside the washing vessel in the washing step, it is possible to raise the boiling point of the solvent. Based on this, even in the case of the solvent being high temperature or the like, evaporation of the solvent is curbed, and the dissolution amount of polyamide in the washing step will tend to be secured. Based on this, the washing efficiency of the cake is improved, and the polyamide recovery loss can be further reduced.

(2) In the polyamide recovery method as described in (1), the fiber includes glass fiber,

the polyamide includes polyamide 6, and

the solvent includes ethylene glycol.

According to the present configuration, upon recovering “polyamide 6” using “ethylene glycol” from polyamide mixed with fibers such the “glass fiber reinforced polyamide” containing “glass fibers” and “polyamide 6”, it is possible to reduce the recovery loss of “polyamide 6”.

(3) In the polyamide recovery method as described in (1) or (2), the method repeatedly performs, for a plurality times, a series of steps including the dissolution step, the first separation step, the solution recovery step, the washing step, the second separation step and the solvent recovery step, and a second time and later of the dissolution step uses the post-wash solvent recovered in the solvent recovery step prior to a current dissolution step as the solvent in the current dissolution step.

According to the present configuration, the post-wash solvent used in the washing step and in which polyamide is somewhat dissolved can be reused as the solvent in subsequent dissolution steps. This post-wash solvent in which polyamide is further dissolved by reuse thereof is recovered in the solution recovery step as the polyamide solution. For this reason, the polyamide dissolved in the solvent by washing in the washing step, and the polyamide further dissolved in the post-wash solvent in the subsequent dissolution step can be collectively recovered efficiently.

(4) In the polyamide recovery method as described in any one of (1) to (3), the washing step is performed in a state heating inside the washing vessel.

According to the present configuration, the polyamide in the cake can be easily dissolved in the solvent by heating inside the washing vessel. The washing efficiency of the cake is thereby improved, and the polyamide recovery loss can be further reduced.

(5) In the polyamide recovery method as described in any one of (1) to (4), the washing step is performed in a state pressurizing inside the washing vessel by filling inert gas into the washing vessel.

According to the present configuration, by pressurizing inside the washing vessel with an inert gas, it is possible to suppress oxidation of the polyamide to be recovered, compared to a case of pressurizing inside the washing vessel with an active gas such as oxygen.

(6) In the polyamide recovery method as described in (5), the second separation step is performed by pressure filtration based on a pressure of the inert gas.

According to the present configuration, by effectively utilizing the pressurization by the inert gas in the washing step, it is possible to perform pressure filtration in the second separation step.

(7) In the polyamide recovery method as described in any one of (1) to (6), the washing step sprays the solvent so as to flow along the inner circumferential surface of the washing vessel, by spraying the solvent by a sprayer parallel to an inner circumferential surface of the washing vessel, or in a direction gradually approaching the inner circumferential surface, in a cross-sectional view of a top surface.

According to the present configuration, it is possible to efficiently supply the solvent also to the cake at the edges within the washing vessel. Based on this, the solvent can be efficiently supplied to all of the cake within the washing vessel. Based on this, the washing efficiency of the cake is improved, and the polyamide recovery loss can be further reduced.

(8) In the polyamide recovery method as described in any one of (1) to (7), the washing vessel includes a storage portion, and includes, above the storage portion, a tapered portion for guiding the cake into the storage portion, and the polyamide recovery method includes loading the cake into the storage portion from the tapered portion, in a state heating the tapered portion.

According to the present configuration, by heating the tapered portion, the viscosity of the polyamide solution in the cake lowers. Bridges in the cake thereby are unlikely to form. Based on this, the cake easily passes through the lower end of the tapered portion, etc., and the cake is easily guided to the storage portion.

(9) In the polyamide recovery method as described in (8), heating of the tapered portion is performed at a power higher than heating of the storage portion.

According to the present configuration, the effects described in the above (8) tend to be more reliably achieved.

(10) A polyamide recovery system for recovering polyamide using a solvent from polyamide mixed with fibers as a product containing fibers and the polyamide includes:

a dissolver that immerses the polyamide mixed with fibers in a solvent to dissolve the polyamide in the solvent;

a first separator that separates a polyamide solution as the solvent in which the polyamide is dissolved, and a cake containing the fibers from each other;

a solution recoverer that recovers the polyamide solution;

a washer that washes the cake with a solvent in a pressurized washing vessel;

a second separator that separates a post-wash solvent as the solvent after washing the cake, and the cake after washing from each other; and

a solvent recoverer that recovers the post-wash solvent.

Similarly to the case of the method of (1), the present system can also reduce polyamide recovery loss.

As mentioned above, according to the configurations of (1) and (9), it is possible to reduce polyamide recovery loss. Furthermore, each of the additional effects can be obtained by the configurations of (2) to (8) which cite (1).

### BRIEF DESCRIPTION OF THE DRAWINGS

FIG. 1 is a schematic diagram showing a polyamide recovery method and a polyamide recovery system according to a first embodiment; and

FIG. 2 is a view showing a cross section along the line Fg2-Fg2 in FIG. 1.

### DETAILED DESCRIPTION OF THE INVENTION

Hereinafter, embodiments of the present invention will be described while referencing the drawings. However, the present invention is not to be limited in any way to the following embodiments, and can be implemented by modifying as appropriate within a scope not departing from the gist of the present invention.

### First Embodiment

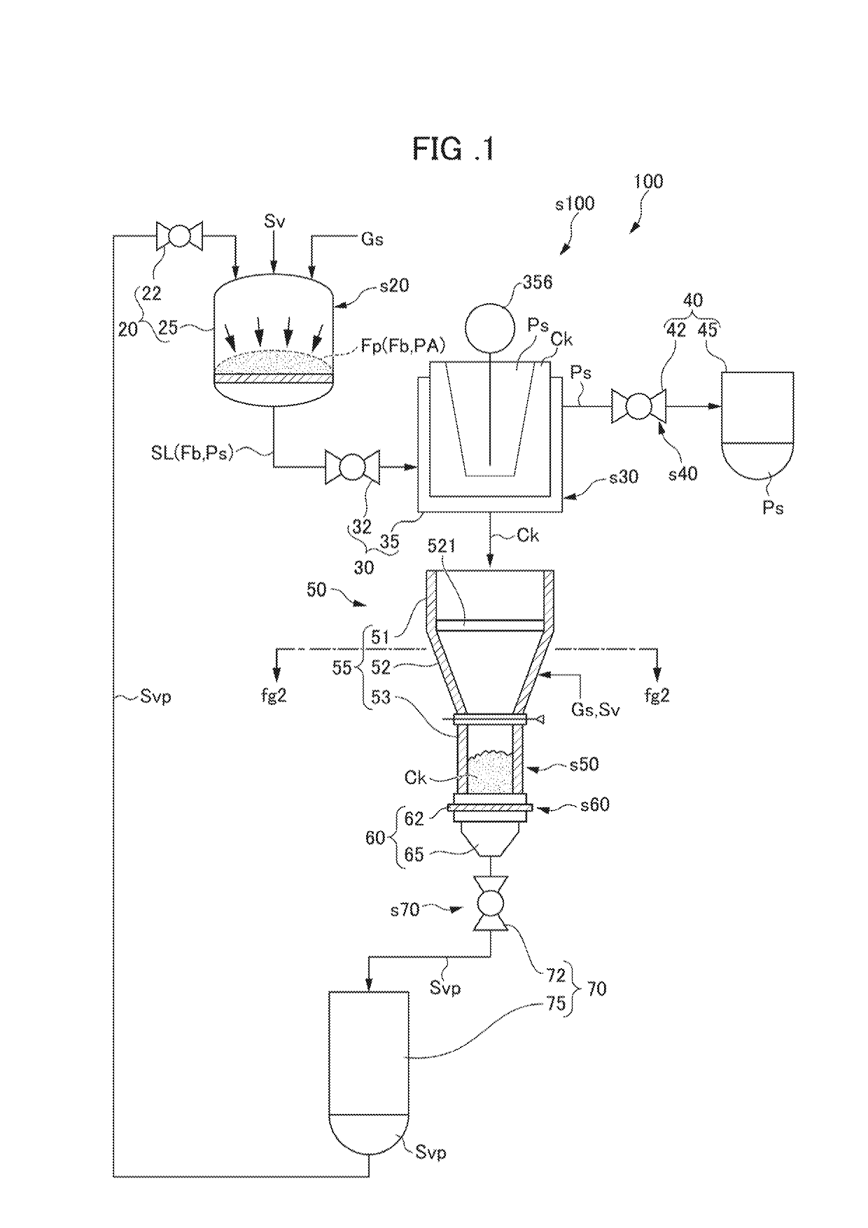

A polyamide recovery method s100 shown in FIG. 1 separates and recovers polyamide PA from polyamide mixed with fibers Fp including fibers Fb and the polyamide PA using a solvent Sv. It should be noted that, in the present embodiment, the polyamide mixed with fibers Fp include “glass fiber” and “polyamide 6”. In other words, the fibers Fb referred to in the present embodiment includes “glass fiber”, and the polyamide PA referred to in the present embodiment includes “polyamide 6”. In addition, in the present embodiment, the solvent Sv includes “ethylene glycol”. Hereinafter, a solution containing the solvent Sv and the polyamide PA dissolved therein is referred to as “polyamide solution Ps”.

The polyamide recovery method s100 includes a dissolution step S20, a first separation step S30, a solution recovery step s40, a washing step s50, a second separation step s60 and a solvent recovery step s70 shown below.

In the dissolution step s20, the polyamide mixed with fibers Fp are immersed in the solvent Sv under pressure from an inert gas Gs, whereby the polyamide PA in the polyamide mixed with fibers Fp is dissolved in the solvent Sv. A slurry SLcontaining the fibers Fb and the polyamide solution Psis thereby generated. It should be noted that nitrogen, carbon dioxide, helium, neon, argon, xenon, krypton, radon and the like can be exemplified as the inert gas Gs.

In the first separation step s30, a majority of the polyamide solution Ps is separated from the slurry SL. In the solution recovery step s40, this separated polyamide solution Ps is recovered.

Hereinafter, the residue after the majority of the polyamide solution Ps is removed by centrifugation of the slurry SL is called “cake Ck”. Consequently, a majority of the cake Ck is the fiber Fb; however, a certain amount of polyamide PA and solvent Sv is included therein.

In the washing step s50, the cake Ck is washed with the solvent Sv under pressure from the inert gas Gs. Hereinafter, the solvent Sv after washing the cake Ck is called “post-wash solvent Svp”. The post-wash solvent Svp contains a small amount of polyamide PA.

In the second separation step s60, the post-wash solvent Svp is separated from the cake Ck after washing, by pressure filtration using the inert gas Gs.

The solvent recovery step s70 recovers this separated post-wash solvent Svp.

The polyamide recovery method s100 repeatedly performs a series of steps including the dissolution step S20, first separation step S30, solution recovery step s40, washing step s50, second separation step s60 and solvent recovery step s70 shown above. However, in the second time and later dissolution steps s20, the post-wash solvent Svp recovered in the solvent recovery step s70 prior to this dissolution step s20 is used as the solvent Sv in this dissolution step s20.

A polyamide recovery system 100 is a system for performing the polyamide recovery method s100 shown above. Based on this, the polyamide recovery system 100 includes a dissolving device 20, a first separation device 30, a solution recovery device 40, a washing device 50, a second separation device 60 and a solvent recovery device 70.

The dissolving device 20 is a device for performing the dissolution step s20. The dissolving device 20 includes a supply valve 22 and a dissolving vessel 25. When the supply valve 22 is opened, the post-wash solvent Svp in a solvent recovery vessel 75 described later is supplied into the dissolving vessel 25. For example, a cooling pipe is installed in the dissolving vessel 25 so that the solvent Sv refluxes.

The first separation device 30 is a device for performing the first separation step s30. The first separation device 30 includes a supply valve 32 and a centrifuge 35. When the supply valve 32 is opened, the slurry SL produced in the dissolving vessel 25 is supplied to the centrifuge 35. The centrifuge 35 is driven by a motor 356.

A solution recovery device 40 is a device for performing the solution recovery step s40. The solution recovery device 40 includes a recovery valve 42 and a solution recovery vessel 45. When the recovery valve 42 is opened, the polyamide solution Ps separated from the slurry SL in the centrifuge 35 is recovered in the solvent recovery vessel 45.

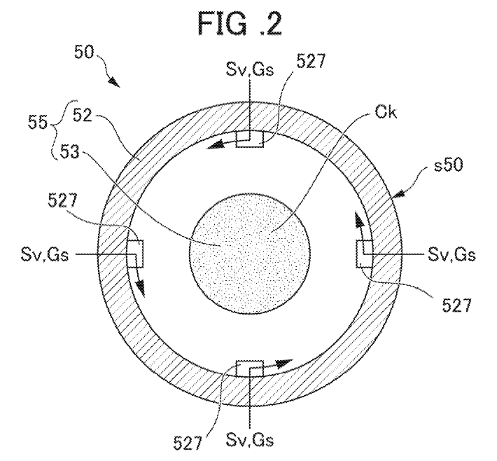

The washing device 50 is a device for performing the washing step s50, and includes a washing vessel 55. This washing vessel 55 includes, in order from above, a loading portion 51, a tapered portion 52 and a storage portion 53. In a cross-sectional view of the top surface shown in FIG. 2, the inner circumferential surface of the storage portion 53 is circular. As shown in FIG. 1, the tapered portion 52 is a part for leading the cake Ck loaded into the loading portion 51 to the storage portion 53, and becomes gradually thinner as approaching downwards from above. The tapered portion 52 and the storage portion 53 are configured to allow for heating. More specifically, the tapered portion 52 is closer to a heat source than the storage portion 53. Based on this, the heating of the tapered portion 52 is performed at a higher power than the heating of the washing vessel 55. An upper end 521 of the tapered portion 52 is configured to be openable.

The second separation device 60 is a device for performing the second separation step s60. The second separation device 60 includes a filter 62 and a solvent recovery tank 65. The filter 62 is mounted so as to cover a lower-side opening of the storage portion 53. Based on this, a bottom of the storage portion 53 is configured by the filter 62. The solvent recovery tank 65 is provided below the filter 62.

The solvent recovery device 70 is a device for performing the solvent recovery step s70. The solvent recovery device 70 includes a recovery valve 72 and a solvent recovery vessel 75. When the recovery valve 72 is opened, the post-wash solvent Svp in the solvent recovery tank 65 is recovered in the solvent recovery vessel 75.

The dissolution step s20 is performed in the dissolving vessel 25, in a state in which the supply valve 22 of the dissolving device 20 and the supply valve 32 of the first separation device 30 are closed. In other words, the dissolution step s20 is performed in a closed system.

The cake Ck remaining in the centrifuge 35 after the solution recovery step s40 is loaded to the loading portion 51, in a state opening the upper end 521 of the tapered portion 52. This cake Ck reaches the storage portion 53 by passing through the tapered portion 52 which is being heated. The cake Ckis thereby filled into the storage portion 53. This cake Ck accumulates on the filter 62. In this state, the upper end 521 of the tapered portion 52 is closed.

The washing step s50 and the second separation step s60 are performed in a state heating the tapered portion 52 and the storage portion 53, while closing the upper end 521 of the tapered portion 52, and closing the recovery valve 72 of the solvent recovery device 70. At this time, in the cross section view of a top surface shown in FIG. 2, the inert gas Gs and the solvent Sv are sprayed from a sprayer 527 into the tapered portion 52 in a direction parallel to the inner circumferential surface of the tapered portion 52, or a direction gradually approaching the inner circumferential surface. The solvent Sv is thereby sprayed so as to flow along the inner circumferential surface of the tapered portion 52.

According to the above, in the washing vessel 55 shown in FIG. 1, the cake Ck is washed by the solventSv under pressurization by the inert gas Gs. In addition, together with this, in the filter 62, the post-wash solvent Svp undergoes pressure filtration based on the pressure of the inert gas Gs in the washing vessel 55. Thereafter, when the recovery valve 72 of the solvent recovery device 70 is opened, the pressure within the solvent recovery tank 65 drops, and the pressure difference between the inside of the washing vessel 55 and the solvent recovery tank 65 increases, whereby pressure filtration by the filter 62 further advances.

Next, one specific example of the polyamide recovery method s100 shown above will be exemplified. In this specific example, the polyamide mixed with fiber Fp is 50 kg of crushed product of intake manifolds. In this polyamide mixed with fiber Fp, polyamidePA consisting of “polyamide 6” is contained in 70% by mass ratio (35 kg), and the fiber Fb consisting of “glass fiber” is contained in 30% by mass ratio (15 kg).

In the dissolution step s20, the polyamide mixed with fiber Fp, which is 50 kg of crushed product of intake manifolds is immersed for 1 hour in the solvent Sv consisting of 105 kg of ethylene glycol at a dissolution temperature of 170°C. The slurry SL thereby generated is pressure fed to the centrifuge 35 under a flowrate of 800 kg/h or less by the pressure from the inert gas Gs in the dissolving vessel 25, when the supply valve 32 of the first separation device 30 is opened.

In the first separation step s30, this centrifuge 35 is operated at the setting of 3100 G centrifugal force. From the slurry SL, 20 kg of the cake Ck is thereby separated. In addition to the 15 kg of fiber Fb contained in the 50 kg of polyamide mixed with fiber Fp being contained in this cake Ck, 1.25 kg of the polyamide PA among the 35 kg of the polyamide PA contained in this polyamide mixed with fiber Fp, and 3.75 kg of the solvent Sv among the 105 kg of the solvent Svadded in the dissolution step s20 are contained in this cake Ck.

This cake Ck is loaded to the washing vessel 55. From this, 20 kg of the cake Ckaccumulates on the filter 62, which is as a 20 μm metal filter.

In the washing step s50, the solvent Sv consisting of 100 kg of ethylene glycol heated to 170°C is supplied into the washing vessel 55 with 0.1 MPa of the inert gas Gs. The cake Ck is thereby washed by the solventSv, and the majority of the 1.25 kg of the polyamidePA contained in the cake Ck is dissolved in the solvent Sv.

Hereinafter, the configuration and effects of the present embodiment will be summarized.

After separating the polyamide solution Ps and the cake Ck from each other in the first separation step s30, this cake Ck is washed with the solvent Sv in the washing step s50. It is thereby possible to dissolve, in the solvent Sv, the polyamide PA remaining in the cake Ck. The polyamide PA remaining in the cake Ck is thereby decreased, whereby the recovery loss of the polyamide PA can be reduced.

Moreover, by pressurizing inside the washing vessel 55, it is possible to raise the boiling point of the solvent Sv in the washing step s50. Based on this, even in the case of the solvent Sv being at high temperature, or the like, evaporation of the solvent Sv is curbed, and the dissolution amount of polyamide PA in the washing step s50 will tend to be secured. Based on this, the washing efficiency of the cake Ckis improved, and the recovery loss of the polyamide PAcan be further reduced.

More specifically, in the present embodiment, the fibers Fb include “glass fiber”, the polyamide PA includes “polyamide 6”, and the solvent Sv includes “ethylene glycol”. Based on this, upon recovering “polyamide 6” using “ethylene glycol” from the “glass fiber reinforced polyamide” containing “glass fibers” and “polyamide 6”, it is possible to reduce the recovery loss of “polyamide 6”.

In the second time and later dissolution steps s20, the post-wash solvent Svp recovered in the solvent recovery step s70 before this dissolution step s20 is used as the solvent Sv in this dissolution step s20. Based on this, the post-wash solvent Svp used in the washing step s50 and in which polyamide PA is somewhat dissolved can be reused as the solvent Sv in subsequent dissolution steps s20. This post-wash solvent Svp in which polyamide PA is further dissolved by reuse thereof is recovered in the solution recovery step s40 as the polyamide solution Ps. For this reason, the polyamide PA dissolved in the solvent Sv by washing in the washing step s50, and the polyamide PA further dissolved in the post-wash solvent Svp in the subsequent dissolution step s20 can be collectively recovered efficiently.

The washing step s50 is performed in a state heating inside the washing vessel 55. Based on this, the polyamide PA in the cake Ck can be easily dissolved in the solvent Sv. Based on this, the washing efficiency of the cake Ck is improved, and the recovery loss of the polyamide PA can be further reduced.

The washing step s50 is performed in a state pressurizing inside the washing vessel 55 by filling inside the washing vessel 55 with the inert gas Gs. Based on this, it is possible to suppress oxidation of the polyamide PA to be recovered, compared to a case of pressurizing inside the washing vessel 55 with an active gas such as oxygen.

The second separation step s60 is performed by pressure filtration based on the pressure of this inert gas Gs. For this reason, by effectively utilizing the pressurization by the inert gas Gs in the washing step s50, it is possible to perform pressure filtration in the second separation step s60. Additionally, by suppressing evaporation of solvent and maintaining the dissolution state of the polyamide PA, it is possible to further reduce the recovery loss of polyamide PA.

In the cross-sectional view of the top surface shown in FIG. 2, by spraying the solvent Svfrom the sprayer 527 parallel to the inner circumferential surface of the tapered portion 52, or in a direction gradually approaching this inner circumferential surface in the washing step s50, the solvent Sv is sprayed so as to flow along the inner circumferential surface of the tapered portion 52. Based on this, it is possible to efficiently supply the solvent Sv also to the cake Ck at corners within the washing vessel 55. Based on this, the solvent Sv can be efficiently supplied to all of the cake Ck within the washing vessel 55. Based on this, the washing efficiency of the cake Ckis improved, and the recovery loss of the polyamide PA can be further reduced.

In a state heating the tapered portion 52 shown in FIG. 1, the cake Ck is loaded from the tapered portion 52 into the storage portion 53. By heating the tapered portion 52 in this way, the viscosity of the polyamide solution Ps in the cake Ck lowers. Bridges in the cake Ck thereby are unlikely to form. Based on this, the cake Ck easily passes through the lower end of the tapered portion 52, etc., and the cake Ck is easily guided to the storage portion 53.

Moreover, heating of this tapered portion 52 is performed at higher power than the heating of the storage portion 53. Based on this, the above effects tend to be more reliably achieved.

### Other Embodiments

The embodiment illustrated above can be modified as follows, for example. The fiber Fb may include fibers other than glass fibers, either replacing or in addition to the glass fibers. In addition, the polyamide PA may include polyamide other than polyamide 6, either replacing or in addition to the polyamide 6. In addition, the solvent Sv may include solvent other than ethylene glycol, either replacing or in addition to ethylene glycol.

### EXPLANATION OF REFERENCE NUMERALS

20 dissolving device

30 first separation device

40 solution recovery device

50 washing device

52 tapered portion

527 sprayer

53 storage portion

55 washing vessel

60 second separation device

70 solvent recovery device

100 polyamide recovery system

s20 dissolution step

s30 first separation step

s40 solution recovery step

s50 washing step

s60 second separation step

s70 solvent recovery step

s100 polyamide recovery method

Ck cake

Fb fiber

Fp polyamide mixed with fiber

Gs inert gas

PA polyamide

Ps polyamide solution

Sv solvent

Svp post-wash solvent

What is claimed is:

1. A polyamide recovery method for recovering polyamide using a solvent from a polyamide mixed with fiber as a product containing fiber and polyamide, the method comprising:
a dissolution step of immersing the polyamide mixed with fiber in a solvent to dissolve the polyamide in the solvent;
a first separation step of separating a polyamide solution as the solvent in which the polyamide is dissolved, and a cake including the fiber from each other;
a solution recovery step of recovering the polyamide solution;
a washing step of washing the cake with a solvent inside a washing vessel that is pressurized therein;
a second separation step of separating a post-wash solvent as the solvent after washing the cake, and the cake after washing from each other; and
a solvent recovery step of recovering the post-wash solvent.

2. The polyamide recovery method according to claim 1, wherein
the fiber includes glass fiber,
the polyamide includes polyamide 6, and
the solvent includes ethylene glycol.

3. The polyamide recovery method according to claim 1, wherein the method repeatedly performs, for a plurality times, a series of steps including the dissolution step, the first separation step, the solution recovery step, the washing step, the second separation step and the solvent recovery step, and
a second time and later of the dissolution step uses the post-wash solvent recovered in the solvent recovery step prior to a current dissolution step as the solvent in the current dissolution step.

4. The polyamide recovery method according to claim 1, wherein the washing step is performed in a state heating inside the washing vessel.

5. The polyamide recovery method according to claim 1, wherein the washing step is performed in a state pressurizing inside the washing vessel by filling inert gas into the washing vessel.

6. The polyamide recovery method according to claim 5, wherein the second separation step is performed by pressure filtration based on a pressure of the inert gas.

7. The polyamide recovery method according to claim 1, wherein the washing step sprays the solvent so as to flow along the inner circumferential surface of the washing vessel, by spraying the solvent by a sprayer parallel to an inner circumferential surface of the washing vessel, or in a direction gradually approaching the inner circumferential surface, in a cross-sectional view of a top surface.

8. The polyamide recovery method according to claim 1, wherein the washing vessel includes a storage portion, and includes, above the storage portion, a tapered portion for guiding the cake into the storage portion, and
wherein the polyamide recovery method includes loading the cake into the storage portion from the tapered portion, in a state heating the tapered portion.

9. The polyamide recovery method according to claim 8, wherein heating of the tapered portion is performed at a power higher than heating of the storage portion.

10. A polyamide recovery system for recovering polyamide using a solvent from polyamide mixed with fibers as a product containing fibers and the polyamide, the system comprising:
a dissolver that immerses the polyamide mixed with fibers in a solvent to dissolve the polyamide in the solvent;
a first separator that separates a polyamide solution as the solvent in which the polyamide is dissolved, and a cake containing the fibers from each other;
a solution recoverer that recovers the polyamide solution;
a washer that washes the cake with a solvent in a pressurized washing vessel;
a second separator that separates a post-wash solvent as the solvent after washing the cake, and the cake after washing from each other; and
a solvent recoverer that recovers the post-wash solvent.
